(19) United States
(12) Patent Application Publication
(10) Pub. No.: US 2024/0005662 A1
(43) Pub. Date: Jan. 4, 2024

(54) SURGICAL INSTRUMENT RECOGNITION FROM SURGICAL VIDEOS

(71) Applicant: Verb Surgical Inc., Santa Clara, CA (US)

(72) Inventors: Bokai ZHANG, Santa Clara, CA (US); Darrick STURGEON, Santa Clara, CA (US); Arjun SHANKAR, Santa Clara, CA (US); Varun GOEL, Santa Clara, CA (US); Jocelyn BARKER, San Jose, CA (US)

(21) Appl. No.: 18/345,845

(22) Filed: Jun. 30, 2023

Related U.S. Application Data
(60) Provisional application No. 63/357,413, filed on Jun. 30, 2022.

(51) Int. Cl. G06V 20/40; G06V 10/77; G06V 10/82

(52) U.S. Cl. CPC G06V 20/46; G06V 10/7715; G06V 10/82; G06V 2201/034

(57) ABSTRACT

A machine learning model has two stages. In a first stage, features from one or more frames of a surgical video are extracted, wherein the features include presence of a surgical instrument and type of the surgical instrument. A second stage analyzes the surgical video based on the extracted features to recognize a video segment, wherein the recognized video segment includes a detected presence of the surgical instrument, and where the video segment is recognized by a multi-stage temporal convolution network (MS-TCN) or a vision transformer. Other aspects are also described and claimed.

### CROSS-REFERENCE TO RELATED APPLICATION

This patent application claims the benefit of U.S. Provisional Patent Application No. 63/357,413, entitled “Surgical Instrument Recognition From Surgical Videos” filed 30 Jun. 2022.

### FIELD

The disclosure here generally relates to automated or computerized techniques for processing digital video of a surgery, to detect what frames of the video have an instrument present (that is used in the surgery.)

### BACKGROUND

Temporally locating and classifying instruments in surgical video is useful for analysis and comparison of surgical techniques. Several machine learning models have been developed to do so which can detect where in the video (which video frames) have the presence of a hook, grasper, scissors, etc.

### SUMMARY

One aspect of the disclosure here is a machine learning model that has an action segmentation network preceded with an EfficientNetV2 featurizer, as a technique (a method or apparatus) that temporally locates and classifies instruments (recognizes them) in surgical videos. The technique may perform better in mean average precision than any previous approaches to this task on the open source Cholec80 dataset of surgical videos. When using ASFormer as the action segmentation network, the model outperforms LSTM and MS-TCN architectures while using the same featurizer. The recognition results may then be added as metadata associated with the analyzed surgical video, for example inserted into the corresponding surgical video file or by annotating the surgical vide file. The model reduces the need for costly human review and labeling of surgical video and could be applied to other action segmentation tasks, driving the development of indexed surgical video libraries and instrument usage tracking. Examples of these applications are included with the results to highlight the power of this modeling approach.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 shows a block diagram illustrating an example of the machine learning model.

FIG. 2a is a block diagram of a MS-TCN.

FIG. 2b illustrates an ASFormer.

FIG. 3a illustrates an example encoder block of the ASFormer.

FIG. 3b illustrates an example encoder block of the ASFormer.

FIG. 4 shows an example of recognitions made by the model for a given surgical video.

FIG. 5a illustrates an example graphical user interface for a first application that presents recognition results of the machine learning model to help surgeons evaluate their performances.

FIG. 5b illustrates an example graphical user interface for a search function of a library of annotated surgical videos.

FIG. 5c depicts a presentation by an instrument usage time application.

### DETAILED DESCRIPTION

Video-based assessment (VBA) involves assessing a video recording of a surgeon's performance, to then support surgeons in their lifelong learning. Surgeons upload their surgical videos to online computing platforms which analyze and document the surgical videos using a VBA system. A surgical video library is an important feature of online computing platforms because it can help surgeons document and locate their cases efficiently.

To enable indexing through a surgical video library, video-based surgical workflow analysis with Artificial Intelligence (AI) is an effective solution. Video-based surgical workflow analysis involves several technologies including surgical phase recognition, surgical gesture and action recognition, surgical event recognition, and surgical instrument segmentation and recognition, along with others. This disclosure focuses on surgical instrument recognition. It can help to document surgical instrument usage for surgical workflow analysis as well as index through the surgical video library.

In this disclosure, long video segment temporal modeling techniques are applied to achieve surgical instrument recognition. In one aspect, a convolutional neural network called EfficientNetV2 (Tan and Le 2021) is applied to capture the spatial information from video frames. Instead of using Long Short-Term Memory (LSTM) (Hochreiter and Schmidhuber 1997) or Multi-Stage Temporal Convolutional Network (MS-TCN) (Farha and Gall 2019) for full video temporal modeling, a Transformer for Action Segmentation (ASFormer) (Yi et al. 2021) is used to capture the temporal information in the full video to improve performance. This version of the machine learning model is also referred to here as EfficientNetV2-ASFormer. It outperforms previous state-of-the-art designs for surgical instrument recognition and may be promising for instrument usage documentation and surgical video library indexing.

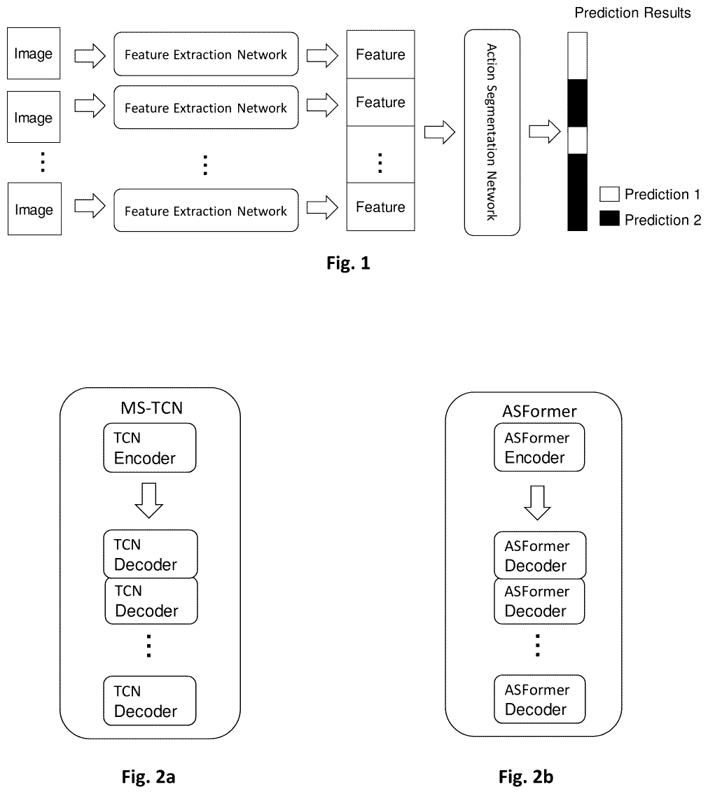

FIG. 1 illustrates a block diagram of constituent elements of the machine learning model. A feature extraction network is pretrained with video frames (the “Image” blocks shown in the figure) extracted from the surgical video dataset. Next, features (the “Feature” blocks in the figure) are extracted for each video frame in each video in the surgical video dataset, using the feature extraction network. Next, frame features are concatenated to produce video features as the training data for the action segmentation network. Finally, the action segmentation network is trained using the video features, to detect surgical instrument presence. Examples of the two elements of the model, the feature extraction network, and the action segmentation network, are described next.

### Feature Extraction Network

For feature extraction, the EfficientNetV2 developed by Tan and Le (2021) may be used. The EfficientNetV2 technique is based on EffientNetV1, a family of models optimized for FLOPs and parameter efficiency. It uses Neural Architecture Search (NAS) to search for a baseline architecture that has a better tradeoff between accuracy and FLOPs. The baseline model is then scaled up with a compound scaling strategy, scaling up network width depth and resolution with a set of fixed scaling coefficients.

EfficientNetV2 was developed by studying the bottlenecks of EfficientNetV1. In the original V1, training with very large image sizes was slow, so V2 progressively adjusts the image size. EfficientNetV2 implements Fused-MBConv in addition to MBConv to improve training speed. EfficientNetV2 also implements a non-uniform scaling strategy to gradually add more layers to later stages of the network. Finally, EfficientNetV2 implements progressive learning: data regularization and augmentation are increased along with image size.

### Action Segmentation Network

In one aspect of the machine learning model here, the action segmentation network of the model is MS-TCN which is depicted by an example block diagram in FIG. 2a. MS-TCN is a recent state-of-the-art architecture in action segmentation, which has improved on previous approaches by adopting a fully convolutional architecture for processing the temporal dimension of the video (Farha and Gall 2019). Because of its convolutional nature, the MS-TCN can be trained on much larger videos than an LSTM approach, and still performs well on both large and small segments. The MS-TCN consists of repeated blocks or “stages”, where each stage consists of a series of layers of dilated convolutions with residuals from the previous layer. The dilation factor increases exponentially with each layer, which increases the receptive field of the network allowing detection of larger segments. The inputs to the MS-TCN are generally class probabilities or features from a frame-level model trained on the dataset and applied to the video. In one aspect, the EfficientNetV2 architecture is used for this purpose.

In another aspect of the machine learning model here, the action segmentation network is a natural language processing (NLP) module that performs spatial-temporal feature learning. In one instance, the NLP module is based on a transformer model, for example a vision transformer. Transformers (Vaswani et al. 2017) are utilized for natural language processing tasks. Recent studies showed the potential of utilizing transformers or redesigning them for computer vision tasks. Vision Transformer (ViT) (Dosovitskiy et al. 2020) which is designed for image classification may be used as the vision transformer. Video Vision Transformer (ViViT) (Arnab et al. 2021) is designed and implemented for action recognition. For the action segmentation network here, Transformer for Action Segmentation (ASFormer) (Yi et al. 2021) was found to outperform several state-of-the-art algorithms and is depicted in FIG. 2b. As shown in FIG. 2b, ASFormer has an encoder-decoder structure like MS-TCN++ (Li et al. 2020). The encoder of ASFormer generates initial predictions from pre-extracted video features. These initial predictions are then passed to the decoders of ASFormer for prediction refinement, to result in a recognition.

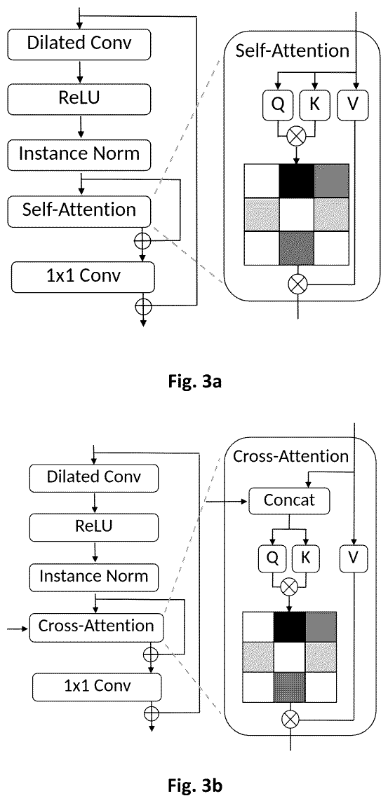

The first layer of the ASFormer encoder is a fully connected layer that helps to adjust the dimension of the input feature. It is then followed by serials of encoder blocks as shown in FIG. 3a. Each encoder block contains a feed-forward layer and a single-head self-attention layer. Dilated temporal convolution is utilized as the feed-forward layer instead of a pointwise fully connected layer. The receptive fields of each self-attention layer within a local window with size w which can be calculated by w=2i (1) where i represents the ith layer.

The dilation rate in the feed-forward layer increases accordingly as the local window size increases. The decoder of ASFormer contains serials of decoder blocks. As shown in FIG. 3b, each decoder block contains a feed-forward layer and a cross-attention layer. Like the self-attention layer, dilated temporal convolution is utilized in the feed-forward layer. Different from the self-attention layer, the query Q and key K in the cross-attention layer are obtained from the concatenation of the output from the encoder and the previous layer. This cross-attention mechanism can generate attention weights to enable every position in the encoder to attend to all positions in the refinement process. In each decoder, a weighted residual connection is utilized for the output of the feed-forward layer and the cross-attention layer:

out=alpha×cross-attention(feed_forward_out)+feed_forward_out (2)

where feed_forward_out is the output from the feed-forward layer, alpha is the weighted parameter. Set the number of decoders to 1 and set alpha to 1 for our study on the Cholec80 surgical video dataset.

### Applications

Some applications of the above-described two-stage machine learning-based method for surgical instrument recognition in surgical videos are now described, as follows. FIG. 6a is a surgical instrument navigation bar in a graphical user interface that also displays the surgical video that has been analyzed. A video play bar controls the start and pause of playback of the video. A step navigation bar indicates the time intervals associated with different steps or phases of the surgery, respectively, and adjacent is the timeline of the recognized instruments (Tool 1, Tool 2, etc.) in each phase shown in an instrument navigation bar. When surgeons review their cases on the online platform, they can utilize the surgical instrument navigation bar and the surgical step navigation bar to move to time periods of interest in the video in a more efficient manner. Combined with additional analytics, this may provide surgeons with a visual correlation between their instrument usage and key moments of the surgery.

Another application is an AI-based intelligent video search whose keywords can be entered into a dialog box, as shown in FIG. 6b. This search function compares the entered keywords to labels or tags (annotations) that have been previously added as metadata of the surgical videos that are stored in the online video library. The surgical videos can be automatically tagged with keywords that refer to for example the instruments that are being used in the video and that have been recognized, based on the results output by the machine learning models that have analyzed the videos. In addition, the surgical workflow recognition models can tag and trim surgical steps or phases automatically. Surgical event detection models can tag and trim surgical events as shorter video clips. With various machine learning models working together on processing each surgical video, users can input keywords like procedure name, surgical step or phase name, surgical event name, and/or surgical instrument name to efficiently locate videos in a large online video library.

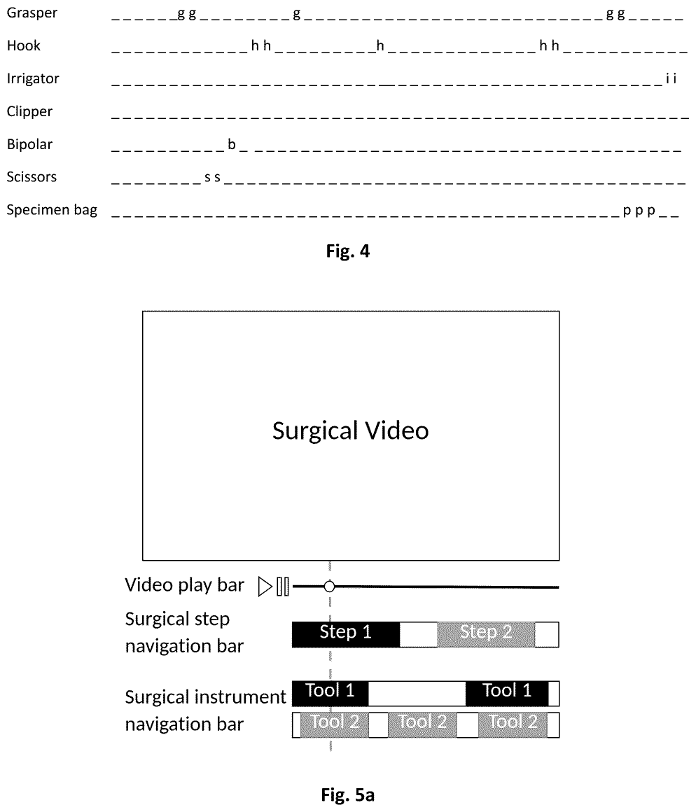

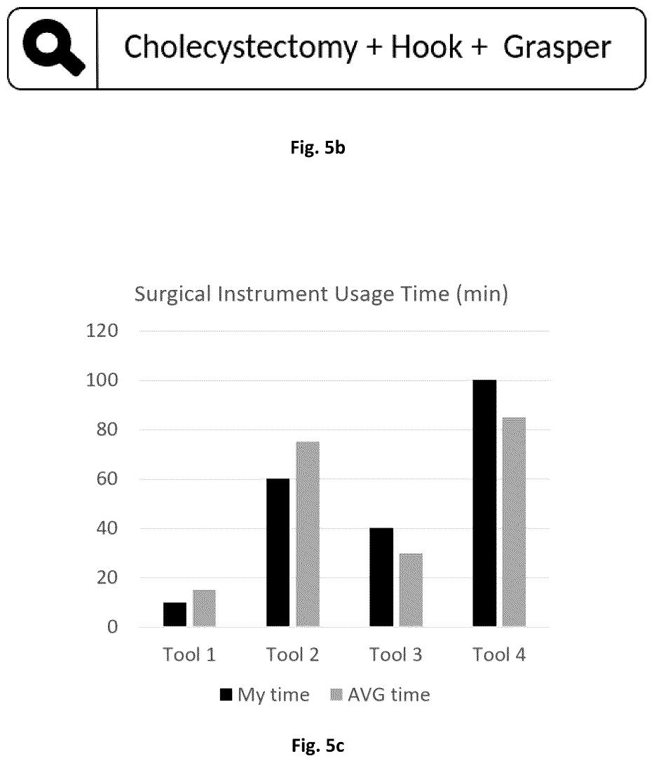

A third application is an instrument usage documentation and comparison tool having a graphical user interface, for example as shown in FIG. 5c. The tool collects recognition results over time (see FIG. 4) and aggregates them to compute usage time for each instrument on a per surgeon basis (the “My time” value in the figure), as well as over some population of surgeons and for the same type of surgery (a benchmark such as an average or some other central tendency.) These surgical instrument usage times are then made available online (e.g., via a Website) to surgeons who can quickly grasp a comparison between their usage time for an instrument and the benchmark usage time. Such a surgical instrument usage time benchmark and adjacent My Time may be combined with the recognized surgical steps, to help surgeons identify differences in their practice versus their peers.

The methods described above are for the most part performed by a computer system which may have a general purpose processor or other programmable computing device that has been configured, for example in accordance with instructions stored in memory, to perform the functions described herein.

While operations are depicted in the drawings in a particular order, this should not be understood as requiring that such operations be performed in the order shown or in sequential order, or that all illustrated operations be performed, to achieve desirable results. Moreover, the separation of various system components in the various aspects described in this document should not be understood as requiring such separation in all cases. Only a few implementations and examples are described, and other implementations, enhancements and variations can be made based on what is described and illustrated in this document.

What is claimed is:

1. A system comprising:
one or more processors and a memory storing instructions executed by the one or more processors, configured to:
extract a plurality of features including one or more surgical instrument types and a presence of a plurality of surgical instruments, from a surgical video, on a frame by frame basis; and
for a respective surgical instrument in the plurality of surgical instruments, analyze the surgical video based on the extracted features to recognize one or more video segments, each recognized video segment including a detected presence of the respective surgical instrument,
wherein the one or more video segments are recognized by a multi-stage temporal convolution network (MS-TCN) or a natural language processing (NLP) module.

2. The system of claim 1, wherein the NLP module uses the one or more processors to perform spatial-temporal feature learning.

3. The system of claim 1, wherein the NLP module is based on a transformer model.

4. The system of claim 3, wherein the transformer model includes an encoder network and a decoder network.

5. The system of claim 1, wherein the one or more processors are further configured to present a surgical instrument navigation bar illustrating a timeline of usage for the respective surgical instrument detected in the surgical video.

6. The system of claim 1, wherein the one or more processors are further configured to facilitate a search interface where responsive to input keywords, video segments matching the input keywords are presented.

7. The system of claim 6, wherein the input keywords include surgical procedure type, surgical steps, surgical events, and/or surgical instrument types and presence.

8. The system of claim 1, wherein the one or more processors are further configured to: collect statistics on a plurality of instances of the detected presence of the surgical instrument where each instance is from a respective surgical video in which a respective surgeon is operating and present the collected statistics to users.

9. The system of claim 1, wherein the one or more processors are further configured to filter the one or more video segments of detected surgical instrument based on filtering rules set by a human actor.

10. The system of claim 1, wherein the one or more processors are further configured to filter the one or more video segments of detected surgical instrument based on a prior knowledge noise filtering (PKNF) algorithm.

11. A method performed by a programmed computer for recognizing instruments in a surgical video, the method comprising:
extracting a plurality of features from one or more frames of the surgical video, wherein the features include presence of a surgical instrument and type of the surgical instrument; and
analyze the surgical video based on the extracted features to recognize a video segment, wherein the recognized video segment includes a detected presence of the surgical instrument, the video segment being recognized by a multi-stage temporal convolution network (MS-TCN) or a vision transformer.

12. The method of claim 11 wherein the video segment is recognized by the vision transformer, and extracting the features comprises doing so by EfficientNetV2 featurizer.

13. The method of claim 12 wherein the vision transformer is ASFormer.

14. The method of claim 11 further comprising presenting a surgical instrument navigation bar illustrating a timeline of usage for the surgical instrument detected in the surgical video.

15. The method of claim 11 further comprising implementing or facilitating a search interface that responsive to input keywords, identifies and displays video segments matching the input keywords.

16. The method of claim 15, wherein the input keywords include surgical procedure type, surgical steps, surgical events, and/or surgical instrument types and presence.

17. The method of claim 11 further comprising collecting statistics on a plurality of instances of the detected presence of the surgical instrument where each instance is from a respective surgical video in which a respective surgeon is operation and present the collected statistics to users.

18. An article of manufacture comprising memory having stored therein instructions that configure a computing device recognize instruments in a surgical video by:
extracting a plurality of features from one or more frames of the surgical video, wherein the features include presence of a surgical instrument and type of the surgical instrument; and
analyze the surgical video based on the extracted features to recognize a video segment, wherein the recognized video segment includes a detected presence of the surgical instrument, the video segment being recognized by a multi-stage temporal convolution network (MS-TCN) or a vision transformer.

19. The article of manufacture of claim 18 wherein the instructions configure the computing device to recognize the video segment by the vision transformer and extract the features by EfficientNetV2 featurizer.

20. The article of manufacture of claim 19 wherein the vision transformer is ASFormer.
